(19) United States
(12) Patent Application Publication
(10) Pub. No.: US 2023/0186264 A1
(43) Pub. Date: Jun. 15, 2023

(54) AUTOMATIC MINTING OF EVENTS

(71) Applicant: Maple Leaf Sports & Entertainment Partnership, Toronto (CA)

(72) Inventors: William REYES, Markham (CA); Nicole RIDOUT, Toronto (CA); Farah BASTIEN, Toronto (CA); Christian MAGSISI, Ajax (CA); Humza TEHERANY, Etobicoke (CA); Tim HUGHES, Toronto (CA)

(73) Assignee: Maple Leaf Sports & Entertainment Partnership, Toronto, ON (CA)

(21) Appl. No.: 18/065,378

(22) Filed: Dec. 13, 2022

Related U.S. Application Data
(60) Provisional application No. 63/265,371, filed on Dec. 14, 2021.

(51) Int. Cl. G06Q 20/12; G06V 20/40

(52) U.S. Cl. CPC G06Q 20/1235; G06V 20/42; G06V 20/44; G06Q 2220/165

(57) ABSTRACT

An example of an apparatus to mint rare events from sports data is provided. The apparatus includes a communications interface to receive sports data from an external source. The sports data is associated with a plurality of events. The apparatus also includes a memory storage unit to store the sports data. In addition, the apparatus includes an analysis engine to identify an event from the plurality of events in the sports data. The apparatus also includes a call engine to call a first oracle. The first oracle is to publish the event on a distributed ledger via a smart contract. A second oracle is to provide criteria to the distributed ledger to determine if the event on the distributed ledger triggers minting. A token associated with the event is minted when triggered.

### CROSS-REFERENCE TO RELATED APPLICATIONS

The present application claims priority from U.S. provisional application Ser. No. 63/265,371 for “AUTOMATIC MINTING OF EVENTS”, filed Dec. 14, 2021, which is incorporated by reference herein in its entirety.

### BACKGROUND

Non-fungible tokens are used to generate a unique and verifiable asset that can be traded via a distributed ledger or blockchain. Non-fungible tokens have recently gained popularity for use in association for collectibles. For example, a digital asset, such as a video, image, or artwork, can be minted with a non-fungible token to verify a copy as original. The process of transforming a digital asset into something unique with a non-fungible token is called minting and generally carried out on a distributed ledger after a user creates or selects a digital asset to mint.

### SUMMARY

In accordance with an aspect of the invention, there is provided an apparatus. The apparatus includes a communications interface to receive sports data from an external source. The sports data is associated with a plurality of events. The apparatus further includes a memory storage unit to store the sports data. In addition, the apparatus includes an analysis engine to identify an event from the plurality of events in the sports data. Furthermore, the apparatus includes a call engine to call a first oracle. The first oracle is to publish the event on a distributed ledger. A second oracle is to provide criteria to the distributed ledger to determine if the event on the distributed ledger triggers minting. A token associated with the event is minted when triggered.

The sports data may be a data feed. The data feed may include a text description. The text description may include an identifier to classify the event. The sports data may be recorded in real time. The distributed ledger may be triggered to mint the event when the event is special. The apparatus may further include a classifying engine to determine whether the event is to be classified as special.

In accordance with an aspect of the invention, there is provided a system. The system includes a communications interface to receive sports data from an external source. The sports data is associated with a plurality of events. The system further includes a memory storage unit to store the sports data. The system also includes an analysis engine to separate the plurality of events in the sports data. Furthermore, the system includes a first oracle to publish each event of the plurality of events on a distributed ledger via a first smart contract. In addition, the system includes a second oracle to communicate with a second smart contract on the distributed ledger. The second smart contract is to analyze the plurality of events to identify an event to mint. The second smart contract mints a token associated with the event.

The system may further include a decentralized application to trade the token. In addition, the system may further include a decentralized storage to store digital assets associated with the token.

In accordance with another aspect of the invention, there is provided a method. The method involves receiving sports data from an external source. The sports data is associated with a plurality of events. Furthermore, the method involves storing the sports data in a memory storage unit. The method further involves separating the plurality of events in the sports data. The method also involves calling a first oracle to publish each event of the plurality of events on a distributed ledger via a first smart contract. The method additionally involves calling a second oracle to communicate with a second smart contract on the distributed ledger. The second smart contract is to analyze the plurality of events to identify an event to mint. In addition, the method involves minting a token associated with the event identified by the second contract.

### BRIEF DESCRIPTION OF THE DRAWINGS

Reference will now be made, by way of example only, to the accompanying drawings in which:
FIG. 1 is a block diagram of an example apparatus to mint rare events from sports data;
FIG. 2 is a block diagram of another example apparatus to mint rare events from sports data;
FIG. 3 is a diagram of an example system to mint rare events from sports data with the apparatus shown in FIG. 1;
FIG. 4 is a block diagram of another example apparatus to mint rare events from sports data;
FIG. 5 is a diagram of another example system to mint rare events from sports data with the apparatus shown in FIG. 1;
FIG. 6 is a diagram of another example system to mint rare events from sports data with the apparatus shown in FIG. 1;
FIG. 7 is a diagram of another example system to mint rare events from sports data with the apparatus shown in FIG. 1; and
FIG. 8 is a flowchart of an example method of minting rare events from sports data.

### DETAILED DESCRIPTION

Rare individual events from a larger set of events, such as an entire sports match, may be used to generate digital assets that can hold value if authenticated and verified to be an actual event. For example, a player's first goal or a player's hundredth goal may be converted into a digital asset. To ensure the verifiability of the digital asset, a non-fungible token may be minted. The selection and minting of an event is generally a manual process. For example, a user may watch a sporting event to manually identify a rare individual event, such as a milestone for a player or team. Accordingly, the process to mint a rare event from sports may take a few days, as the content is obtained from a provider, a digital asset is generated, and a non-fungible token is subsequently minted to attach the token to the digital asset.

Smart contracts are used to carry out operations on the distributed ledger. In general, smart contracts operating within the distributed ledger cannot inherently interact with data that is not on the distributed ledger or blockchain in order to maintain the integrity of the data on the distributed ledger or blockchain. Accordingly, data including digital assets, such as a video, image, or artwork, as well as commands is to be transferred onto the distributed ledger prior to being minted by a smart contract, or acted on by a smart contract, respectively. To transfer data between the distributed ledger or blockchain and the external world, an oracle is used to facilitate the transfer of data between the distributed ledger or blockchain and the external world of the data, such as data providers, end users, etc.

An apparatus, system, and associated method to mint rare events are provided. In the present example, the sports data is received and added to a distributed ledger. Once the entirety of the sports data is stored on the distributed ledger, a verifiable record of a sporting match or a large sporting event is generated. Individual events may be identified and further smart contracts may be applied to the individual events within the larger sporting event to mint rare events.

Referring to FIG. 1, a schematic representation of an example of an apparatus to mint rare events from sports data is generally shown at 50. The apparatus 50 may include additional components, such as additional memory storage units and databases, additional interfaces to communicate with other devices, and further input and output devices to interact with a user or an administrator of the apparatus 50. In addition, the apparatus 50 may be separated into multiple components operating as a system. In some examples, the components may be distributed across multiple locations and operate as a cloud service. In the present example, the apparatus 50 includes a communications interface 55, a memory storage unit 60, an analysis engine 65, and a call engine 70. Although the present example shows the analysis engine 65 and the call engine 70 as separate components, in other examples, the analysis engine 65 and the call engine 70 may be part of the same physical component, such as a microprocessor configured to carry out multiple functions.

The communications interface 55 is to communicate with other devices or services over a network. In particular, the communications interface 55 is to receive sports data from an external source or a plurality of external sources. The sports data is not particularly limited and may include data associated with a plurality of events, such as the events from a game or sporting match. In the present example, an external source may be a media provider, such as a sports network providing a data feed of a sporting match, such as a game.

The manner by which the communications interface 55 connects an external source to the apparatus 50 is not limited and may include different types of networks. Furthermore, it is to be appreciated by a person of skill with the benefit of this description that the communications interface 55 may be configured to receive different types of formats of sports data. For example, the sports data may be a data feed generated by a sportscaster observing a game in real time. In particular, the data feed may include a text description of a plurality of events occurring in the game as observed by the sportscaster. In the example of a sports game, such as baseball, basketball, or hockey, the sports data may be a box score of the game. In other examples, the data feed may be received via the communications interface 55 in real time as the game is being played to provide real time sports data. Continuing with this example, the contents of the text description is not limited. In the present example, the text description may include identifiers to classify individual events within the game. For example, an identifier field may include an identifier to events, such as a pass, a goal, a shot, a penalty, a timeout, etc.

In the present example, the memory storage unit 60 is to store the sports data received from an external source via the communications interface 55. The memory storage unit 60 is not particularly limited and may include various types of computer memory devices. For example, the memory storage unit 60 may include a non-transitory machine-readable storage medium that may be, for example, an electronic, magnetic, optical, or other physical storage device. In the present example, the memory storage unit 60 is to store the sports data in a database 61.

The analysis engine 65 is to identify and separate events that are represented in the sports data. In the present example, the sports data stored in the database 61 may be a string of text that is continuously received from an external source. Continuing with the example above, the sportscaster may continually generate sports data as a game is occurring, such as by calling the game and converting the game to text. In the present example, the text includes identifiers to identify discrete events that are being described. Accordingly, the analysis engine 65 may scan for the identifiers to identify individual events. The format in which the events are stored after identification by the analysis engine 65 is not particularly limited. For example, the analysis engine 65 may normalize the data to facilitate downstream processing.

The manner by which the sports data in the database 61 is normalized is not particularly limited. In the present example, the sports data in the database 61 is scanned to extract relevant information to create a standardized data record by populating fields based on the received sports data. Continuing with the above example, the sports data received may be a text string where the order in which the information is presented, as well as the references to players, is inconsistent. For example, portions of the sports data may refer to a player by their last name and in other portions, the sports data may refer to the same player by a jersey number. The format of the standardized data record is not particularly limited and may be in a unique format.

It is to be appreciated by a person of skill with the benefit of this description that in further examples, the sports data may have been generated with a text-to-speech engine and resemble the natural language of a sportscaster calling a sporting match in real time. In this example, the analysis engine 65 may include a natural language processing engine to extract information from the sports data. The manner by which the information may be extracted is not particularly limited and may include using a machine learning engine to analyze the sports data.

The call engine 70 is to make calls to oracles that are in communication with a distributed ledger or blockchain. The call engine 70 is not particularly limited and may be a custom application programming interface in some examples. In other examples, another type of interface may be used as the call engine 70. In the present example, the oracle receives data representing the individual events identified by the analysis engine 65 and publishes the data on a distributed ledger or blockchain. The manner by which the oracle publishes the data onto the distributed ledger is not particularly limited and may include executing a smart contract to convert the data received from the memory storage unit 60 to identified events on a distributed ledger or blockchain. Accordingly, this type of oracle may be in communication with a publishing smart contract to connect real world data transmitted by the call engine 70 with data that is stored on the distributed ledger or blockchain. For example, the oracle may communicate with part of the CHAINLINK network to receive the data from the call engine 70.

In the present example, the call engine 70 will call another oracle to communicate with a second smart contract on the distributed ledger to monitor the data being published on the distributed ledger by the first smart contract. This second smart contract is to determine if an event published on the distributed ledger by the first oracle triggers minting of a non-fungible token. If an event stored on the distributed ledger triggers a minting process, the second smart contract will proceed to execute a smart contract to generate a digital asset from the data on the distributed ledger by minting a non-fungible token for the digital asset. The manner by which the smart contract determines whether an event is to trigger a minting process is not particularly limited. For example, the smart contract may compare the event stored on the distributed ledger with a predetermined set of special events, such as a fast play in the game, a hard shot, a trick shot, or a personal or team record, to determine whether an event on the distributed ledger is special. In particular, the predetermined set of special events may include classes of events where some classes are target classes to be minted, such as goals or saves. In other examples, the smart contract may use a classification engine, such as an engine operating a machine learning classifier, to determine whether an event on the distributed ledger is to be considered special to trigger minting.

Referring to FIG. 2, another schematic representation of an example of the components of an apparatus 50a to mint rare events from sports data is generally shown. Like components of the apparatus 50a bear like reference to their counterparts in the apparatus 50, except followed by the suffix “a”. In the present example, the apparatus 50a includes a communications interface 55a, a memory storage unit 60a, an analysis engine 65a, and oracles 75a-1 and 75a-2) generically, these oracles are referred to herein as “oracle 75a” and collectively referred to as “oracles 75a”(.

The analysis engine 65a is to identify and separate events that are represented in the sports data. In particular, the analysis engine 65a may scan for the identifiers to identify individual events to identify rare events.

Upon identifying rare events, the apparatus 50a includes oracles 75a to provide information to the smart contracts. The oracles 75a are not particularly limited and may be a centralized oracle to provide data from the apparatus 50a, such as sports data stored in the memory storage unit 60a or a command, to one or more smart contracts in the distributed ledger. In particular, the oracle 75a-1 may be used to transfer sports data from the memory storage unit 60a to a smart contract configured to upload data to the distributed ledger. Once the sports data is published on the distributed ledger, the sports data may be used by another smart contract to mint a non-fungible token to be associated with an event in the sports data. The initial owner of the non-fungible and the smart contract may mint the non-fungible token to any party. For example, the initial owner may be the operator and owner of the apparatus 50a for subsequent distribution. In other examples, the apparatus 50a may have a list of predetermined identifiers to whom the non-fungible token will be minted. The smart contract may also receive commands and instructions from the oracle 75a-2 to carry out a selection process. The selection process may involve automatically minting events in the distributed ledger that satisfy a predetermined criteria. For example, all events added via the oracle 75a-1 may be minted by the smart contract associated with the oracle 75a-2 upon publication to the distributed ledger. In other examples, the oracle 75a-2 may provide further selection criteria to a smart contract. It is to be appreciated by a person of skill with the benefit of this description that some smart contracts may use this selection criteria to identify and mint special events. Accordingly, the smart contract may limit the number of events that are to be minted to avoid the generation of excessive non-fungible tokens, which may reduce the value of each non-fungible token.

Referring to FIG. 3, an example of a system 300 to monitor sports data in real time to mint rare events automatically is generally shown. In the present example, the apparatus 50 is in communication with a distributed ledger 105, an external device 320, and external sources 330 via a network 310. It is to be appreciated that the external device 320 and the external sources 330 are not particularly limited and variations of devices capable of performing similar functions may be substituted. Furthermore, although the present example illustrates two external sources 330, additional external sources may be added to the system 300.

The external device 320 may be any type of electronic device used to access sports data and to purchase or exchange non-fungible tokens. Some examples of devices that may be used as an external device 320 are a smartphone, a tablet, a laptop, a desktop computer, or any other device capable of receiving user input and generating user output. In the present example, the external device 320 includes its own communications interface and processor. The external device 320 may also include input, such as from a keyboard, pointer, and or touchscreen, and/or output devices, such as a display or touchscreen display.

Each external source 330 may be a data source providing sports data. For example, the external source 330 may be a recording party attending a sporting event to record data in real time. Some specific examples of the external source 330 include Second Spectrum, Sportsradar, Play-by-play Data, Signal R, ESPN Broadcasting Feed, Statsbomb, and Twitter Trends.

In the present example, each external source 330 may generate and provide sports data to the apparatus 50. It is to be appreciated by a person of skill with the benefit of this description that multiple external sources 330 may cover a single sporting event to generate sports data from different perspectives. By generating sports data from different perspectives, events in the sporting data may be corroborated or verified. For example, an external source 330 may identify an event as a highlight of the match, while the other external source 330 may not do so for the same event. In some cases, an event may be identified by both external sources 330 to be a highlight. Accordingly, an event identified as a highlight by more external sources may be considered to be a more noteworthy event in the sports data and treated accordingly on the distributed ledger 105 for automatic minting of an associated non-fungible token.

In other examples, the external sources 330 may provide sports data from different sporting events to be processed by the apparatus 50. Accordingly, the apparatus 50 may be processing multiple sporting events in parallel to generate non-fungible tokens associates with highlights and other rare sporting events.

Referring to FIG. 4, another schematic representation of an example of the components of an apparatus 50b to mint rare events from sports data is generally shown. Like components of the apparatus 50b bear like reference to their counterparts in the apparatus 50, except followed by the suffix “b”. In the present example, the apparatus 50b includes a communications interface 55b, a memory storage unit 60b, and a processor 80b.

The memory storage unit 60b is to store the sports data received from an external source via the communications interface 55b. The memory storage unit 60b is not particularly limited and may include various types of computer memory devices similar to the ones discussed above in connection with the memory storage unit 60. For example, the memory storage unit 60b stores sports data in the database 61b, which are substantially similar to their counterparts discussed above. In the present example, the memory storage unit 60a also stores a database of operating instructions 62b. The operating instructions 62b are not particularly limited and may be instructions to be carried out by the processor 80b for the general operation of the apparatus 50b. In particular, the operating instructions 62b may include an operating system that is executable by a processor 80b to provide general functionality to the apparatus 50b. In some examples, the operating instructions 62b may include instructions to operate other components and peripheral devices of the apparatus 50b, such as an input/output device (not shown).

In the present example, the processor 80b may include a central processing unit, a microcontroller, a microprocessor, a processing core, a field-programmable gate array, an application-specific integrated circuit, or similar. The processor 80b may cooperate with the memory storage unit 60b to execute various instructions, such as the operating instructions 62b, stored thereon. The processor 80b is connected to the communications interface 55b and may receive data and/or send or transmit commands or data to an external device or service, such an oracle to publish data on the distributed ledger.

In the present example, the processor 80b may carry out instructions to implement various components of the apparatus 50b. For example, the processor 80b may execute instructions to carry out the functionality of an analysis engine 65b, a call engine 70b, a classification engine 71b, and an authentication engine 72b. In addition, the processor 80b may be programmed to transmit and receive data via the communications interface 55b and to read and write data from the memory storage unit 60b.

The analysis engine 65b is to identify and separate events that are represented in the sports data stored in the database 61b. The manner by which the analysis engine 65b identifies and separates events in the sports data by type is not particularly limited. In the present example, sports data includes text identifiers to identify discrete events that are being described. Accordingly, the analysis engine 65b may scan for the identifiers to identify individual events. In some examples, the sports data may also include identifiers to indicate whether the event is special, such as a highlight event or rare event. Although the insertion of the identifier to indicate a special event may be carried out by a human user recording the real time sporting event, sporting data with these events may be subsequently processed in an automatic manner without further human intervention to publish the sports data on the distributed ledger nor determine whether an event is to be minted to generate a non-fungible token associated with the event.

The call engine 70b is to make calls to oracles that are to publish data onto the distributed ledger. In the present example, the apparatus 50b may be in communication with an external service that is centralized or decentralized to receive sports data from the memory storage unit 60b to be subsequently published on the distributed ledger. The manner by which each oracle transfers the data onto the distributed ledger is not particularly limited and may include providing the sports data to a smart contract in the distributed ledger. In turn, the smart contract in the distributed ledger may publish the data received from the memory storage unit 60b on a distributed ledger or blockchain. Accordingly, this type of oracle may feed the sports data to a publishing smart contract to connect real world data transmitted by the call engine 70b with data that is published on the distributed ledger or blockchain.

In addition, the call engine 70b will call another oracle to initiate a smart contract to monitor the data being published on the block chain by the first oracle. This second oracle may also be associated with another smart contract in the distributed ledger that may determine if an event published on the distributed ledger by the first oracle triggers a process to mint a non-fungible token. If an event published on the distributed ledger triggers the minting process, the smart contract will generate a digital asset from the sporting data on the distributed ledger by minting a non-fungible token.

In the present example, the processor 80b may further execute a classifying engine 71b to determine if an event identified by the analysis engine is special. The manner by which the classifying engine 71b classifies events as special or not special is not particularly limited. In some examples, the classifying engine 71b may execute a script to carry out a rules-based approach where a set of rules is applied to the event data to make the determination.

In other examples, the classifying engine 71b may use a machine learning engine to classify each event. In this example, the model used by the machine learning engine is not limited and may include using various models. For example, the classifying engine 71b may use trained logistic regression classifiers to compare the signature with known signature types. Other examples of machine learning models may include convolutional neural networks, naïve Bayes, support vector machines, decision tree learning, and other classifiers.

The authentication engine 72b is to verify credentials from an external source of data. In order to maintain the integrity of the data to be stored in the memory storage unit 60b, the data feed from each external source may be verified to determine if the external source is authentic or known to the apparatus 50b. Once the identity of the external source is verified, the communication link between the verified external source and the apparatus 50b may be secured. The manner of securing the communication link is not particularly limited. For example, messages transmitted to the external source to the apparatus 50b may be encrypted. In other examples, login credentials may be provided by the external source where the authentication engine 72a carries out a verification step to establish a secure link between the apparatus 50b and the external source where sports data is generated.

Referring to FIG. 5, a schematic representation of an example of a system 100 to mint rare events from sports data is generally shown. In the present example, the apparatus 50 is in communication with a distributed ledger 105, which may be a distributed ledger system where oracles 110 are used to transfer data from the apparatus 50. The data received from the apparatus 50 is to be stored on the distributed ledger 105. In the present example, the oracle 110 is to provide data, such as sports data, to a smart contract in the distributed ledger 105 that publishes the data in the distributed ledger 105. In the present example, the smart contract associated with the oracle 110 may also automatically mint identified events in the sports data being provided from the apparatus 50. Accordingly, the smart contract generates non-fungible tokens.

In the present example, the system 100 further includes a decentralized application 120 to be used to trade the non-fungible tokens minted by a smart contract in the distributed ledger 105 associated with the oracle 110. The manner by which the decentralized application 120 trades non-fungible tokens is not particularly limited. For example, the decentralized application 120 may operate a marketplace where users can access the marketplace via an external device 320 to shop and purchase digital assets, such as a non-fungible token associated with a rare sporting event. It is to be appreciated by a person of skill with the benefit of this description that additional components may be included in the system 100 such as a decentralized storage component to store the digital assets for the marketplace.

Referring to FIG. 6, another schematic representation of an example of a system 100a to mint rare events from sports data is generally shown. Like components of the system 100a bear like reference to their counterparts in the system 100, except followed by the suffix “a”. In the present example, the system 100a includes the apparatus 50, a distributed ledger 105a, oracles 110a-1 and 110a-2) generically, these oracles are referred to herein as “oracle 110a” and collectively referred to as “oracles 110a”(, and includes a decentralized application 120a.

In the present example, the system 100a includes a plurality of oracles 110a. Each oracle 110a may be associated with a separate smart contract in the distributed ledger 105a. For example, the oracle 100a-1 may be associated with a smart contract to transfer and publish data from the apparatus 50 to the distributed ledger 105a. The oracle 100a-2 may then be associated with a smart contract to mint events on the distributed ledger 105a automatically to generated non-fungible tokens. The tokens may then be bought and sold via the decentralized application 120a, which can be accessed by a user through an external device 320.

Referring to FIG. 7, another schematic representation of an example of a system 100b to mint rare events from sports data is generally shown. Like components of the system 100b bear like reference to their counterparts in the system 100, except followed by the suffix “b”. In the present example, the system 100a includes the apparatus 50, a distributed ledger 105b, an oracle 110b, and a decentralized application 120b.

In the present example, the system 100b includes an oracle 110b. The oracle 110b is in communication with the apparatus via a custom application programming interface that allows for sports data to be transferred to the oracle 110b. It is to be appreciated by a person of skill with the benefit of this description that the oracle 110b may not be a single centralized oracle, but instead a plurality of decentralized oracles that are integrated with a plurality of smart contracts 112b in the distributed ledger 105b. The plurality of smart contracts 112b is not particularly limited and may include a variety of specific smart contracts that can publish and process the sports data in the distributed ledger 105b. In addition, a smart contract in the plurality of smart contracts 112b may provide for the automatic minting of an event in the data to generate non-fungible tokens, which can be purchased, sold, and traded via the decentralized application 120b which may be accessed by the external device 320.

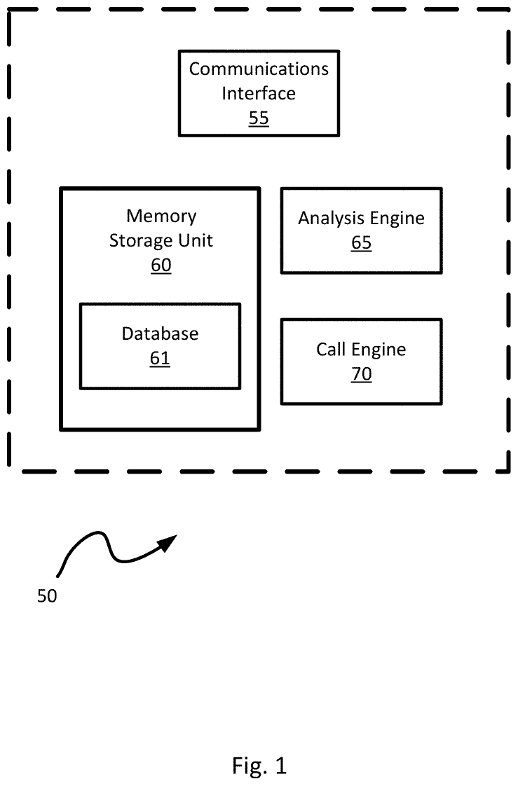

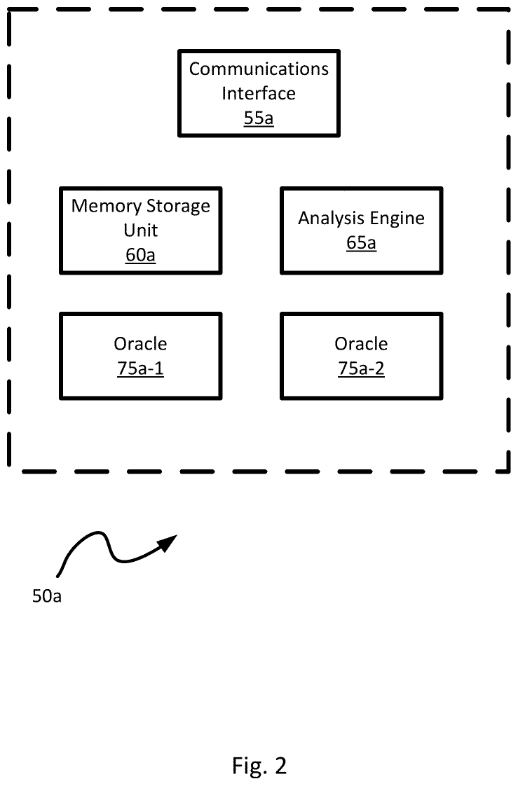

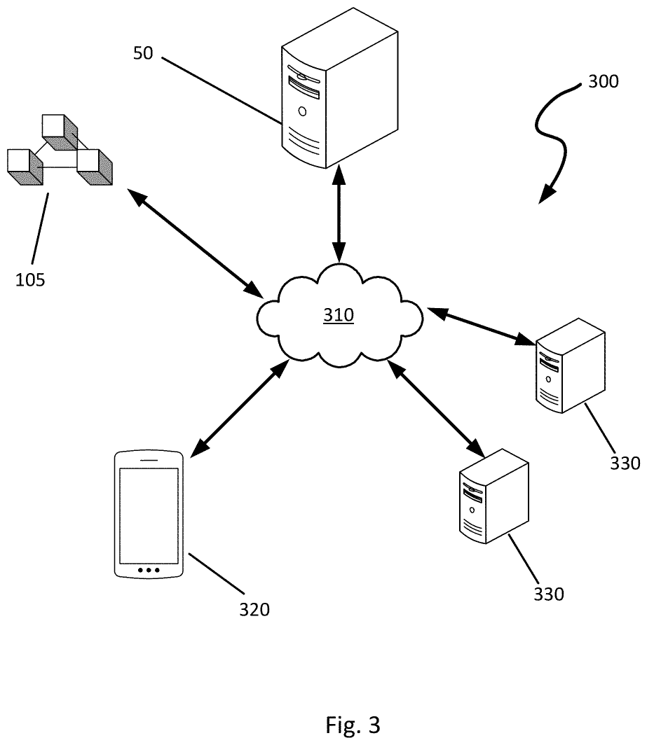

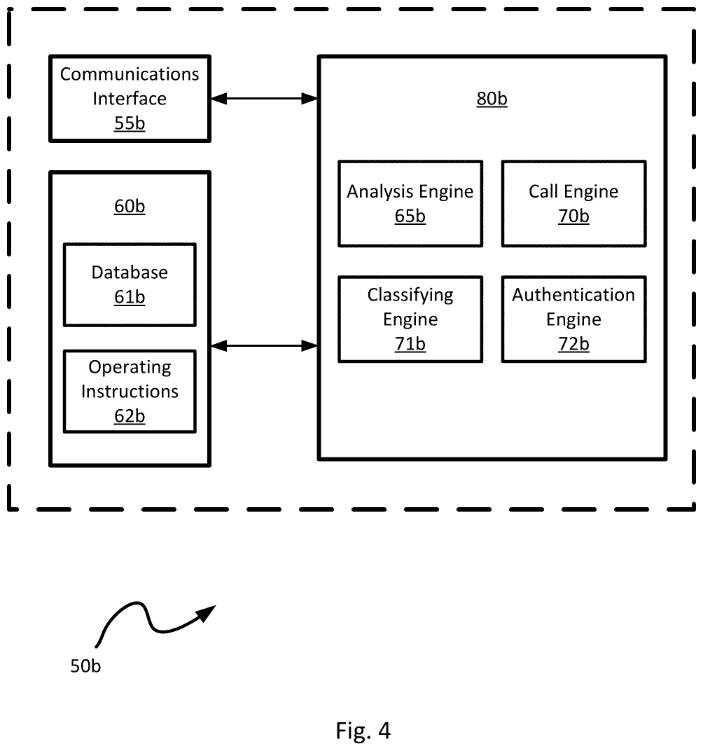

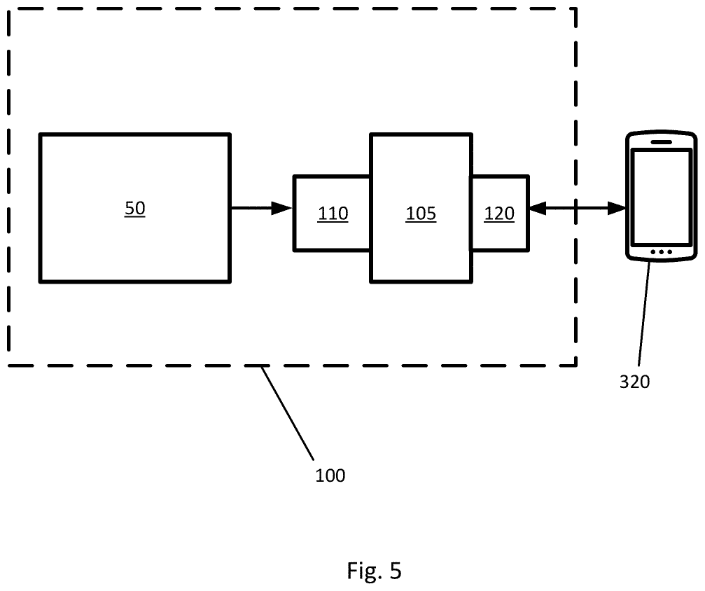

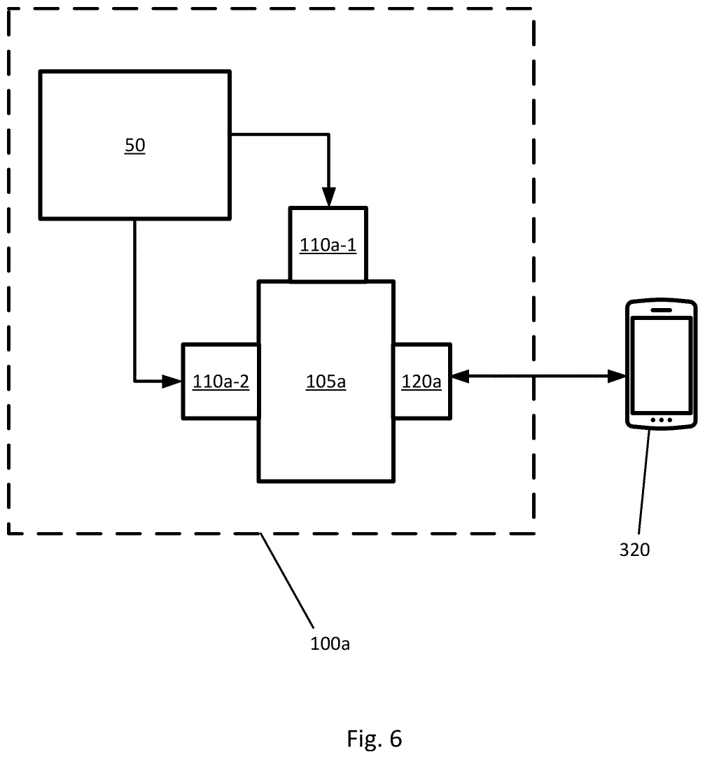

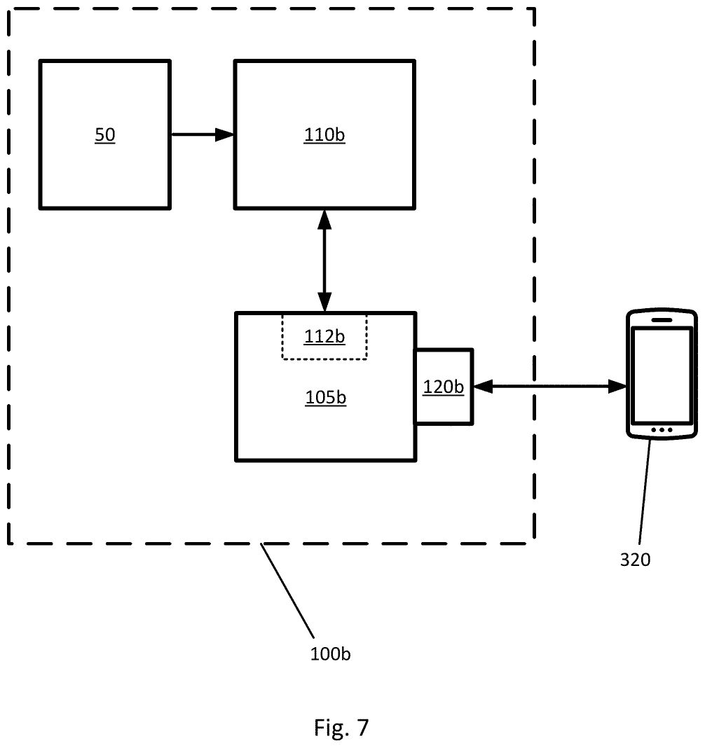

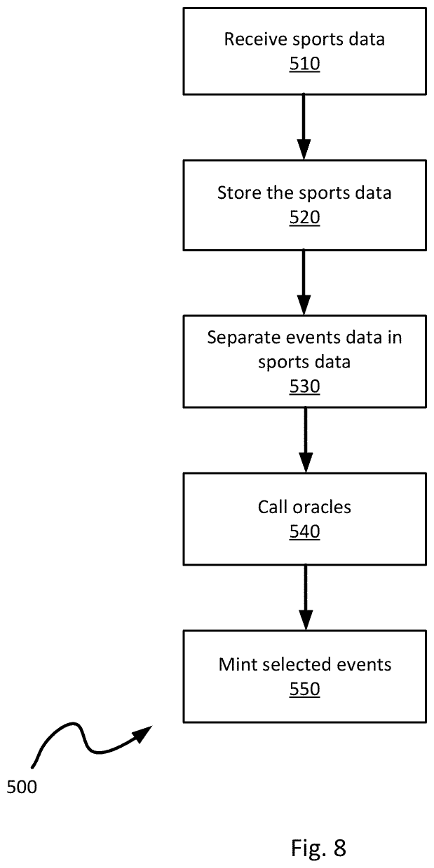

Referring to FIG. 8, a flowchart of an example method of minting rare events from sports data is generally shown at 500. In order to assist in the explanation of method 500, it will be assumed that method 500 may be performed by the apparatus 50 in the system 100. Indeed, the method 500 may be one way in which the apparatus 50 is configured. Furthermore, the following discussion of method 500 may lead to a further understanding of the system 100 and it components. In addition, it is to be emphasized, that method 500 may not be performed in the exact sequence as shown, and various blocks may be performed in parallel rather than in sequence, or in a different sequence altogether.

Beginning at block 510, sports data is received at the apparatus 50 from an external source. In the present example, the sports data is to represent a plurality of events associated with a game or sports match, such as a race or competition. The sports data is then stored in the memory storage unit 60 of the apparatus 50 at block 520.

Next, the analysis engine 65 separates the sports data into a plurality of events represented in the sports data at block 530. In the present example, the sports data is stored in a memory storage unit 60 and may be a string of text that is continuously received from the external source, such as a real time feed from a game. In the present example, the text strings include identifiers to identify discrete events that are being described. Accordingly, the analysis engine 65 may scan for the identifiers to identify individual events to separate them in the stream of sports data.

Next, block 540 calls a first oracle to publish the events identified at block 530 on the distributed ledger 105. In addition, another oracle is called to communicate with a second smart contract to analyze the events on the distributed ledger 105 to identify an event to mint, such as a highlight or rare event. It is to be appreciated by a person of skill with the benefit of this description that the manner by which events are identified for minting is not particularly limited and may include a rules-based approach or with the use of a machine learning based classifier. Once events are identified to be minted, block 550 generates a digital asset from the event and mints a non-fungible token, which may then subsequently be traded via a decentralized application.

Various advantages will now be apparent to a person of skill in the art with the benefit of the present description. For example, the system 100 may be used to listen to real time feeds of sports data to identify rare events automatically and minting a digital asset of the event. By placing the events from the feed of sports data onto a distributed ledger, the digital asset may be generated quickly and deployed to a marketplace for sale.

It should be recognized that features and aspects of the various examples provided above may be combined into further examples that also fall within the scope of the present disclosure.

What is claimed is:

1. An apparatus comprising:
a communications interface to receive sports data from an external source, wherein the sports data is associated with a plurality of events;
a memory storage unit to store the sports data;
an analysis engine to identify an event from the plurality of events in the sports data; and
a call engine to call a first oracle, wherein the first oracle is to publish the event on a distributed ledger via a smart contract, and wherein a second oracle is to provide criteria to the distributed ledger to determine if the event on the distributed ledger triggers minting, and wherein a token associated with the event is minted when triggered.

2. The apparatus of claim 1, wherein the sports data is a data feed.

3. The apparatus of claim 2, wherein the data feed includes a text description.

4. The apparatus of claim 3, wherein the text description includes an identifier to classify the event.

5. The apparatus of claim 1, wherein the sports data is collected in real time.

6. The apparatus of claim 1, wherein the distributed ledger is triggered to mint the event when the event is special.

7. The apparatus of claim 6, further comprising a classifying engine to determine whether the event is to be classified as special.

8. An apparatus comprising:
a communications interface to receive sports data from an external source, wherein the sports data is associated with a plurality of events;
a memory storage unit to store the sports data;
an analysis engine to separate the plurality of events in the sports data;
a first oracle to publish each event of the plurality of events on a distributed ledger via a first smart contract; and
a second oracle to communicate with a second smart contract on the distributed ledger, the second smart contract to analyze the plurality of events to identify an event to mint, and wherein the second smart contract mints a token associated with the event.

9. The apparatus of claim 8, wherein the sports data is a data feed.

10. The apparatus of claim 9, wherein the data feed includes a text description.

11. The apparatus of claim 10, wherein the text description includes an identifier to classify each event of the plurality of events into a plurality of classes.

12. The apparatus of claim 11, wherein the second smart contract is to mint events in a target class of the plurality of classes.

13. The apparatus of claim 8, wherein the sports data is collected in real time.

14. The apparatus of claim 8, further comprising a decentralized application to trade the token.

15. A method comprising:
receiving sports data from an external source, wherein the sports data is associated with a plurality of events;
storing the sports data in a memory storage unit;
separating the plurality of events in the sports data;
calling a first oracle to publish each event of the plurality of events on a distributed ledger via a first smart contract;
calling a second oracle to communicate with a second smart contract on the distributed ledger, the second smart contract to analyze the plurality of events to identify an event to mint; and
minting a token associated with the event identified by the second smart contract.

16. The method of claim 15, wherein the sports data is a data feed.

17. The method of claim 16, wherein the data feed includes a text description.

18. The method of claim 17, further comprising classifying each event of the plurality of events into a plurality of classes based on an identifier in the text description.

19. The method of claim 18, further comprising identifying the event of the plurality of events in a target class of the plurality of classes, and minting the event.

20. The method of claim 15, further comprising trading the token via a decentralized application.
